(19) United States
(12) Patent Application Publication
(10) Pub. No.: US 2012/0144241 A1
(43) Pub. Date: Jun. 7, 2012

(54) DEVICE FOR DYNAMIC ANALYSIS OF EMBEDDED SOFTWARE OF VEHICLE

(75) Inventors: Jung Duck Son, Seoul (KR); Se Young Park, Hwaseong (KR); Tai Hyo Kim, Seoul (KR); Ho Jung Bang, Seoul (KR)

(73) Assignees: HYUNDAI MOTOR COMPANY, Seoul (KR); FORMAL WORKS INC., Seoul (KR); KIA MOTORS CORPORATION, Seoul (KR)

(21) Appl. No.: 13/091,516

(22) Filed: Apr. 21, 2011

(30) Foreign Application Priority Data
Dec. 6, 2010 (KR) 10-2010-0123154

(51) Int. Cl. G06F 11/32

(52) U.S. Cl. 714/38.1; 714/E11.188

(57) ABSTRACT

The present invention provides a device for conducting dynamic analysis of embedded software of a vehicle. More particularly, it relates to a device for dynamically analyzing embedded software of the vehicle to detect real time errors of embedded software based on the analysis. More specifically, a data communication unit communicates data in real time with an electronic unit of the vehicle; and a control unit that monitors the condition of one or more hardware components which are used by embedded software of an electric field based on the data received through the data communication unit, and thereby outputs the monitored result accordingly.

### CROSS-REFERENCE TO RELATED APPLICATION

This application claims under 35 U.S.C. §119(a) the benefit of Korean Patent Application No. 10-2010-0123154 filed Dec. 6, 2010, the entire contents of which are incorporated herein by reference.

### BACKGROUND

(a) Technical Field

The present invention relates to a device for dynamic analysis of embedded software of a vehicle. More particularly, it relates to a device for dynamic analysis which can dynamically analyze embedded software of a vehicle and detect in real time errors of the embedded software based on the analysis.

(b) Background Art

An embedded system (built-in system) is a computer system that performs only specific functions by embedding software for operating a system in hardware format. The embedded system has specific requirements and performs predetermined tasks unlike a personal computer (PC). More specifically, the software executed in and by the embedded system is often called embedded software.

Recently, various functions have been implemented to improve the commercial value of vehicles, and accordingly the electronic equipment of these vehicles has become more and more complicated. Accordingly, the embedded software mounted in the vehicle electronic equipment has additionally become more complicated and it takes a long time to implement the software into the vehicle system. Thus, the conception to production time-line is often held up.

Accordingly, OSEK operation systems for vehicles have been developed to make implementation of embedded software easier. OSEK is an abbreviation in German meaning “Offend Systeme and deren Schnittstellen fur die Elektronik im Kraftfahrzeug” and implies an “Open System and the Corresponding Interfaces for Automotive Electronic” in English. More particularly, the OSEK has been established for industrial standardization of open architectures of a distribution controller of a vehicle.

Recently, a growing number of vehicles have become equipped with a software platform which utilizes the OSEK operation system, which comes into wide use for chassis electronic equipment, in addition to BCMs (Body Control Modules).

Although the quality of the operation system has been improved by the software platform, the error rate of the individual embedded software has increased as well due to the complexity of the functions involved. These errors in the embedded software cause errors in the operation of the vehicle's electronic equipment. Accordingly, there is a need to develop a device that can detect and analyze these types of errors.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a device for dynamic analysis which can dynamically analyze embedded software of a vehicle and detect in real time errors in the embedded software based on the analysis process. More particularly, the present invention provides a device for dynamic analysis which can detect the direct factors related to and causes of one or more errors by dynamically analyzing the software level of embedded software based on, e.g., an OSEK operation system.

In one aspect, the present invention provides a device for dynamic analysis of embedded software of a vehicle, which includes: a data communication unit that communicates data in real time with an electronic unit of the vehicle; and a control unit that monitors the condition of one or more computer processing units (CPU) and a memory which are used by embedded software of an electric field, based on the data received through the data communication unit. The results are then output to a monitor for review by a user.

In some embodiments, the control unit monitors a call stack depth of the embedded software of the memory.

In another embodiment, the control unit monitors CPU usage for the embedded software.

In still another preferred embodiment, the control unit monitors error codes detected by a software platform of the embedded software.

In yet another preferred embodiment, the control unit monitors a data value for a specific address of the memory and changes the data value for the address in accordance with input of a user.

Accordingly, it is possible to detect problems in software that otherwise would be difficult to find, by dynamically analyzing embedded software, particularly, software based on the OSEK operation system. Therefore, the device for dynamic analysis of embedded software of a vehicle of the present invention solves quality problems or unknown problems of one or more electronic units which may be generated, by directly detecting errors generated in the embedded software itself and conducting an analysis of these errors to determine the cause of the errors.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a diagram illustrating a configuration and a connection relationship of a device for dynamic analysis of embedded software of a vehicle according to an exemplary embodiment of the present invention;

FIG. 2 is a flowchart illustrating an operation process of a device for dynamic analysis of embedded software of a vehicle according to an exemplary embodiment of the present invention; and

FIG. 3 is a monitoring screen provided by a device for dynamic analysis of embedded software of a vehicle according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### Examples

The following examples illustrate the invention and are not intended to limit the same.

Hereinafter, preferred embodiments of the present invention will be described in detail with reference to the accompanying drawings so that they can be easily carried out by those skilled in the art.

The present invention relates to a device for conducting an analysis of one or more errors in a vehicle system which can dynamically analyze embedded software mounted in an electronic unit of a vehicle and detect one or more errors in real time.

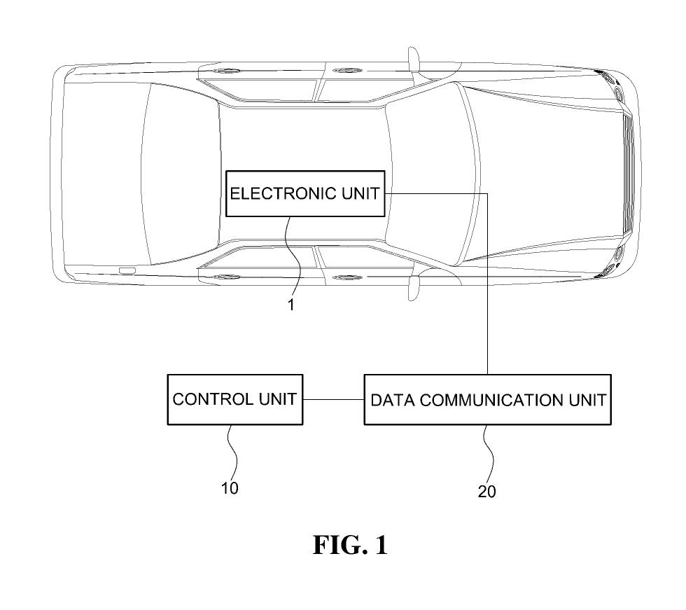

FIG. 1 is a diagram illustrating a configuration and a connection relationship of a device 2 for dynamic conducting an analysis of embedded software of a vehicle according to an illustrative embodiment of the present invention. As shown in the figure, the device according to the present invention includes a data communication unit 20 that communicates with an electronic unit 1 of a vehicle and a control unit 10 that dynamically analyzes embedded software based on data received through the data communication unit 20.

The data communication unit 20 of the illustrative embodiment of the present invention is a device for communicating data, to be examined, in real time with the electronic unit 1. In some embodiments of the present invention, a K-Line (e.g., KWP2000) protocol communication may be used as a communication means between the electronic unit and the device. In this embodiment, the data communication unit 20 converts data of a K-Line protocol, using a converter therein, and transmits the data to the control unit 10, once the data is received.

Furthermore, the control unit 10 according to the illustrative embodiment of the present invention can be configured to monitor the conditions of one or more hardware components, e.g., a CPU (or one or more CPUs) and a memory, which use the embedded software mounted and executed in the electronic unit 1, based on the data received through the data communication unit 20, and thereby output the monitored results accordingly. The control unit 10 can analyze a log associated with the data received while executing the programs in the embedded software, and detect a generated error in real time.

Illustratively, the embedded software may be mounted in an ECU (Electronic Control Unit) of the electronic equipment 1 in the present invention and provided with a software platform providing a variety of monitoring information on the embedded software.

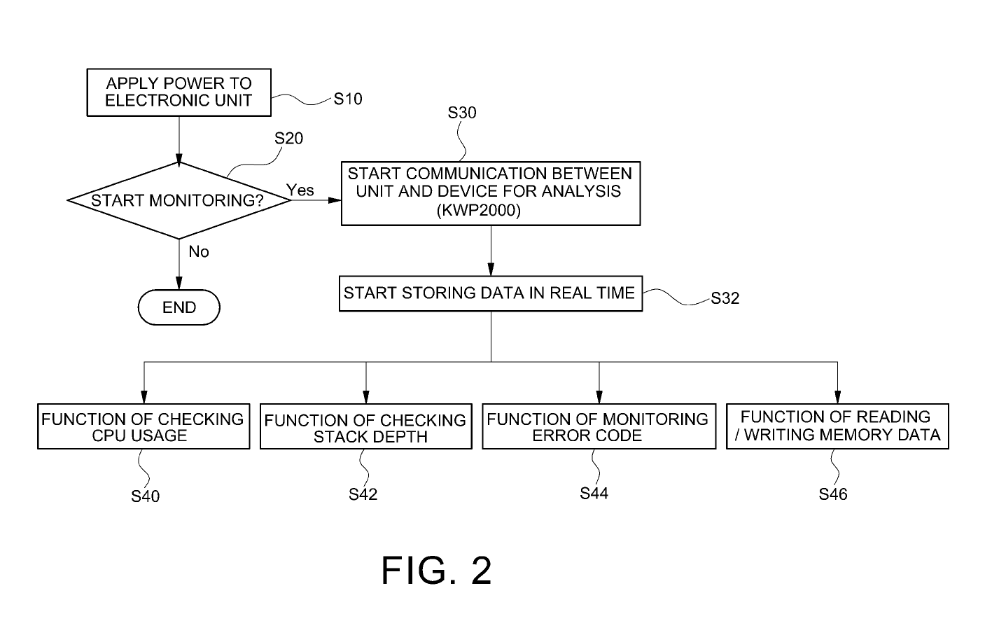

FIG. 2 is a flowchart illustrating the operation process of a device for dynamic analysis of embedded software of a vehicle according to an exemplary embodiment of the present invention.

Power is applied to the electronic unit that is being examined in accordance with the illustrative embodiment of the present invention (S10), and in response to the electronic unit being powered on the electronic unit can then be selected to as an electronic unit to be monitored through the present invention which is connected to the electronic unit (S20). If the electronic unit is selected to be monitored, communication commences between the electronic unit and the device for dynamic analysis in accordance with the illustrative embodiments of the present invention (S30). The communication may be implemented, e.g., by the K-Line (e.g., KWP2000) protocol communication as discussed above.

More specifically, the device for dynamic analysis according to the present invention can receive and store data in real time from the software platform of the electronic unit based on the communication conducted (S32). That is, the device for dynamic analysis may operate to monitor the embedded software based on the received data.

As the device for dynamic analysis according to the present invention starts operating, the device provides dynamic analysis functions, such as a function of checking the CPU usage (S40), a function of checking the call stack depth (S42), a function of monitoring an error code (S44), and/or a function of reading/writing memory data (S46). These functions may be implemented based on the data provided from the software platform of the electronic unit connected with the device for dynamic analysis.

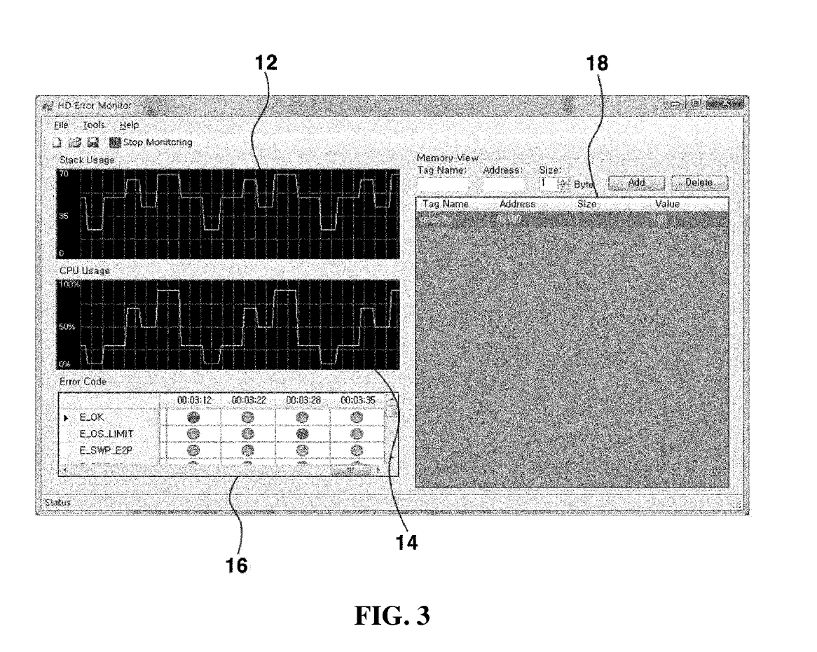

The dynamic analysis functions provided by an embodiment of the present invention are described with reference to FIG. 3.

In some embodiments of the present invention it is necessary to monitor a call stack depth. These embodiments, it is possible to monitor the call stack depth according to execution of the embedded software from the ECU memory equipped with the embedded software (12). That is, the control unit of the present invention can monitor the stack call depth and output it in graphical form to a user, and the user can check and determine when the stack depth infinitely increases. Therefore, the user can see error potential due to an infinite loop and a recursive call.

In yet other embodiments it may be beneficial to monitor the CPU usage of the embedded software and output it in graphical form (14). In these embodiments of the present invention, the user can see a change in CPU load due to the execution of the embedded software through the device of the present invention, and see any malfunction errors due to an overload of the CPU. Furthermore, this function helps to prevent CPU jams due to an abnormal interrupt.

In even other embodiments of the present invention it may be advantageous to monitor the error codes detected by the software platform of the embedded software (16). That is, the control unit can receive the error codes detected by the software platform mounted in the electronic unit and output the error codes to the user accordingly.

Accordingly, the control unit can display changes in the error codes and output the number of times and the time where the error codes were generated. In this process, the CPU time of the ECU and the system time of the control unit according to the present invention may be simultaneously stored, as the time when the error codes was generated.

For example, the error codes when Car electronic Architecture and Network System Software Package (CARNES SWP) is used as the software platform in accordance with an embodiment of the present invention are as follows. CARNES SWP is a platform software program developed by a Korean company. CARNES SWP performs application engineering jobs such as the standard software platform, application software on the basis of the software platform, hardware and evaluation tools for automotive electronic control devices.

TABLE 1

| | | | | Executed result |
|---|---|---|---|---|
| | Error Code | Value | Description of error | to error |
| 1 | E_OK | 0 | No error | None |
| 2 | E_OS_LIMIT | 4 | Multiple activation generated | Reset |
| | | | above allowable value of task | |
| 3 | E_SWP_E2P | 201 | Error in SWP E2PROM | Reset |
| | E_SWP_IO | 202 | Error in SWP IO manager | No Reset |
| 5 | E_SWP_NETWORK | 213 | Error in SWP Network manager | Reset |
| 6 | E_SWP_PLL | 215 | No error in PLL lock | Reset |
| 7 | E_SWP_PORT_REGISTERS | 206 | Photoresist value different | Reset |
| | | | from defined value | |
| 8 | E_SWP_SYSTEM_REGISTERS | 207 | System register value | Reset |
| | | | different from defined value | |
| 9 | E_SWP_UNUSED_INTERRUPT | 210 | Non-used interrupt | Reset |
| 10 | E_SWP_DIVISION_BY_ZERO | 216 | Division by zero error | No Reset |
| 11 | E_SWP_DIAG | 225 | Error in SWP diagnosis | Reset |
| 12 | E_SWP_ASC | 204 | Error in ASC | Reset |

In yet other embodiments of the present invention, data values for specific addresses in the ECU memory can be monitored and changes can be made to the data values based on an input by the user (18). In this embodiment, the control unit of the present invention can provide an input window for inputting addresses and capacities of specific memories to monitor, and display the monitored values (e.g., tag names, addresses, capacities, and data values) of the memories defined by tags. Furthermore, it can simultaneously monitor several memory addresses by defining a plurality of tags to be monitored.

According to some embodiments of the present invention, the controller can also provide an input window for manually changing the data values for the specific addresses of the memories and provide a function for changing the data values for the addresses in accordance with an input by a user. Therefore, the user can directly see abnormalities by analyzing data values for certain addresses in the memory and applying certain values to the above certain addresses in order to change the data values.

Advantageously, the present invention allows the user to detect direct causes and factors relating to one or more errors in embedded software of a vehicle by dynamically analyzing the software level, by receiving data through, for example, a K-Line communication with the electronic unit, monitoring the usage of the CPU and/or the memory for the embedded software from the data, and providing the monitored result to the user. In particular, since the device for dynamic analysis according to the present invention can perform analysis and detect errors in real time while the embedded software is being executed, it is possible to dynamically analyze the embedded software itself.

Furthermore, the present invention may be embodied as computer readable media storage on a computer readable medium containing executable program instructions executed by a processor. Examples of the computer readable recording mediums include ROM, RAM, compact disc (CD)-ROMs, magnetic tapes, floppy disks, and optical data storage devices. The computer readable recording medium can also be distributed in network coupled computer systems so that the computer readable media is stored and executed in a distributed fashion.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A device for dynamic analysis of embedded software of a vehicle, comprising:
a data communication unit that communicates data in real time with an electronic unit of the vehicle; and
a control unit that monitors the condition of one or more computer processing units (CPUs) and a memory which are used by the embedded software of the electric field, based on the data received through the data communication unit, wherein the results of the analysis are output to a user on a display.

2. The device for dynamic analysis of embedded software of a vehicle of claim 1, wherein the control unit monitors a call stack depth of the embedded software of the memory.

3. The device for dynamic analysis of embedded software of a vehicle of claim 1, wherein the control unit monitors CPU usage for the embedded software.

4. The device for dynamic analysis of embedded software of a vehicle of claim 1, wherein the control unit monitors error codes detected by a software platform of the embedded software.

5. The device for dynamic analysis of embedded software of a vehicle of claim 1, wherein the control unit monitors a data value for a specific address of the memory and changes the data value for the address in accordance with input of a user.

6. A method conducting a dynamic analysis of embedded software of a vehicle, comprising:
communicating data via, a data communication unit in a vehicle, in real time between the data communication unit and one or more electronic units of the vehicle to detect errors in the embedded software;
monitoring the conditions of one or more hardware components which are used by the embedded software, based on the data received through the data communication unit; and
displaying the results of the analysis to a user on a display.

7. The method for conducting the dynamic analysis of embedded software of the vehicle of claim 6, further comprising monitoring a call stack depth of the embedded software of the memory.

8. The method for conducting the dynamic analysis of embedded software of the vehicle of claim 6, further comprising monitoring CPU usage for the embedded software.

9. The method for dynamic analysis of embedded software of the vehicle of claim 6, further comprising monitoring error codes detected by a software platform of the embedded software.

10. The method for conducting the dynamic analysis of embedded software of the vehicle of claim 6, further comprising monitoring a data value for a specific address of the memory and changes the data value for the address in accordance with input of a user.

11. A computer readable medium for dynamic analysis of embedded software of a vehicle containing executable program instructions executed by a processor; comprising:
program instructions that communicate data from an electronic unit installed in a vehicle in real time to detect errors in the embedded software; and
program instructions that monitor the condition of one or more hardware components which are used by the embedded software, based on the data received, wherein the results of the analysis are output to a user on a display.

12. The computer readable medium of claim 11, further comprising program instructions that monitor a call stack depth of the embedded software of the memory.

13. The computer readable medium of claim 11, further comprising program instructions that monitor CPU usage for the embedded software.

14. The computer readable medium of claim 11, further comprising program instructions that monitor error codes detected by a software platform of the embedded software.

15. The computer readable medium of claim 11, further comprising program instructions that monitor a data value for a specific address of the memory and change the data value for the address in accordance with input of a user.
